(19) United States
(12) Patent Application Publication
(10) Pub. No.: US 2022/0410001 A1
(43) Pub. Date: Dec. 29, 2022

(54) SYSTEM AND METHOD FOR SUPPORTING CREATION OF GAME SCRIPT

(71) Applicant: CYGAMES, INC., Tokyo (JP)

(72) Inventor: Jeongwon Min, Tokyo (JP)

(73) Assignee: CYGAMES, INC., Tokyo (JP)

(21) Appl. No.: 17/896,649

(22) Filed: Aug. 26, 2022

Related U.S. Application Data
(63) Continuation of application No. PCT/JP2021/007477, filed on Feb. 26, 2021.

(30) Foreign Application Priority Data
Feb. 28, 2020 (JP) 2020-033989

(51) Int. Cl. A63F 13/45; G06F 40/253; G06N 5/04

(52) U.S. Cl. CPC A63F 13/45; G06F 40/253; G06N 5/045

(57) ABSTRACT

One or more embodiments of the invention provides a system for supporting the creation of a game script including natural language data representing explanation text in a game and also including control data for controlling the game, the natural language data and the control data being associated in accordance with the content of the game, the system including: a data pre-processing module that converts control data included in created game scripts created in advance into control explanation text in the form of natural language data and creates processed script text including the explanation text and control explanation text corresponding to the explanation text; and a learning module that generates a trained model by causing a pre-trained natural language model to learn the processed script text, the pre-trained natural language model having learned in advance grammatical structures and text-to-text relationships concerning natural language text.

### TECHNICAL FIELD

The present invention relates to systems and methods for supporting the creation of a game script.

### BACKGROUND ART

Various kinds of games have hitherto been released, including games that are executed on compact portable electronic devices such as smartphones. For example, among games having narrativity, such as RPGs, there are games in which the story proceeds while the standing pictures of characters and the words that are uttered by characters are switched. In such a game having narrativity, the story proceeds according to what is described in a “game script” including scenario text constituted of words that are uttered by characters and also including command sequences, etc. for controlling the proceeding of the story, such as screen transitions.

### CITATION LIST

### Patent Literature

### {PTL 1}

Japanese Unexamined Patent Application, Publication No. 2018-169715

### SUMMARY OF INVENTION

### Technical Problem

In developing game scripts for a game having narrativity, such as the one mentioned above, it has hitherto been necessary to manually enter the entire game scripts, and thus the game-script creating step has been a cost factor in game production. Under this situation, in the development of a game having narrativity, there is a demand for a system for supporting the creation of a game script, which makes it possible to reduce manual intervention without compromising quality. For example, if it becomes possible to automatically create at least a portion of game scripts, such as the input of command sequences for controlling the proceeding, it becomes possible to reduce manual intervention without compromising quality. The applicant has made various efforts for automation in the development of a game having narrativity. For example, Patent Literature 1 discloses a translation support system that makes it possible to reduce translation costs by using a machine translation system.

The present invention has been made in order to solve the problem described above, and it is a main object thereof to provide a system that can support the creation of a game script in the development of a game having narrativity.

### Solution to Problem

A system according to an aspect of the present invention is as follows.

[1] A system for supporting the creation of a game script including natural language data representing explanation text in a game and also including control data for controlling the game, the natural language data and the control data being associated in accordance with the content of the game, the system being characterized by including:

a data pre-processing module that converts control data included in created game scripts created in advance into control explanation text in the form of natural language data and that creates processed script text including the explanation text and control explanation text corresponding to the explanation text; and

a learning module that generates a trained model by causing a pre-trained natural language model to learn the processed script text, the pre-trained natural language model having learned in advance grammatical structures and text-to-text relationships concerning natural language text.

Furthermore, a system according to an aspect of the present invention is as follows.

[2] A system according to [1], wherein:

the control data can be classified into a plurality of types on the basis of functions,

the data pre-processing module, for each type of control data, converts control data included in created game scripts created in advance into control explanation text in the form of natural language data and creates processed script text including the explanation text and control explanation text corresponding to the explanation text, and

the learning module generates a trained model for each type of control data by causing the pre-trained natural language model to learn the processed script text for each type of control data, the pre-trained natural language model having learned in advance grammatical structures and text-to-text relationships concerning natural language text.

Furthermore, a system according to an aspect of the present invention is as follows.

[3] A system according to [2], wherein:

the data pre-processing module includes a plurality of data pre-processing units, and one of the data pre-processing units creates processed script text by converting control data corresponding to one type of control data included in created game scripts into control explanation text, whereby the data pre-processing module creates processed script text for each type of control data, and

the learning module includes a plurality of learning units individually corresponding to the plurality of data pre-processing units.

Furthermore, a system according to an aspect of the present invention is as follows.

[4] A system according to any one of [1] to [3], wherein the learning module generates a trained model by fine-tuning the pre-trained natural language model while using the processed script text as training data.

Furthermore, a system according to an aspect of the present invention is as follows.

[5] A system according to any one of [1] to [4], wherein:

the processed script text further includes explanation text and randomly selected control explanation text, and

the learning module generates a trained model by causing the pre-trained natural language model to learn, as correct data, explanation text included in the processed script text and control explanation text corresponding to the explanation text, and to learn, as incorrect data, the explanation text and the randomly selected control explanation text.

Furthermore, a system according to an aspect of the present invention is as follows.

[6] A system according to any one of [1] to [5], wherein the game script is matrix-form data or structured data, and includes a plurality of identifiers individually corresponding to individual scenes in the game, as well as natural language data and control data associated with the identifiers.

Furthermore, a system according to an aspect of the present invention is as follows.

[7] A system according to [6], wherein:

the game script further includes natural language data representing character names associated with identifiers,

the system further includes a data division unit that classifies the created game scripts on a per-character basis and that stores the per-character created game scripts,

the data pre-processing module, on a per-character basis, converts control data included in created game scripts into control explanation text and creates processed script text including the explanation text and control explanation text corresponding to the explanation text, and

the learning module generates a trained model for each character by causing the pre-trained natural language model to learn the processed script text on a per-character basis.

Furthermore, a system according to an aspect of the present invention is as follows.

[8] A system according to any one of [1] to [7], wherein:

the data pre-processing module converts control data into control explanation text on the basis of conversion information indicating corresponding relationships between control data and control explanation text, and

the system includes:

an input acceptance unit that accepts the input of explanation text in the game;

an inference unit that infers, by using a trained model, control explanation text from explanation text whose input has been accepted by the input acceptance unit, the trained model being generated by causing a pre-trained natural language model to learn processed script text, the pre-trained natural language model having learned in advance grammatical structures and text-to-text relationships concerning natural language text, the processed script text including explanation text included in created game scripts created in advance and control explanation text in the form of natural language data created from control data corresponding to the explanation text; and

a data post-processing unit that creates, on the basis of the conversion information, control data from the control explanation text inferred by the inference unit.

Furthermore, a method according to an aspect of the present invention is as follows.

[9] A method of generating a trained model for supporting the creation of a game script including natural language data representing explanation text in a game and also including control data for controlling the game, the natural language data and the control data being associated in accordance with the content of the game, the method being characterized by including:

a step of converting control data included in created game scripts created in advance into control explanation text in the form of natural language data and creating processed script text including the explanation text and control explanation text corresponding to the explanation text; and

a step of generating a trained model by causing a pre-trained natural language model to learn the processed script text, the pre-trained natural language model having learned in advance grammatical structures and text-to-text relationships concerning natural language text.

Furthermore, a system according to an aspect of the present invention is as follows.

[10] A system for supporting the creation of a game script including natural language data representing explanation text in a game and also including control data for controlling the game, the natural language data and the control data being associated in accordance with the content of the game, the system being characterized by including:

an input acceptance unit that accepts the input of explanation text in the game; and

an inference unit that infers, by using a trained model, control explanation text from explanation text whose input has been accepted by the input acceptance unit, the trained model being generated by causing a pre-trained natural language model to learn processed script text, the pre-trained natural language model having learned in advance grammatical structures and text-to-text relationships concerning natural language text, the processed script text including explanation text included in created game scripts created in advance and control explanation text in the form of natural language data created from control data corresponding to the explanation text.

Furthermore, a system according to an aspect of the present invention further includes:

[11] a data post-processing unit that creates, on the basis of conversion information indicating corresponding relationships between control data and control explanation text, control data from the control explanation text inferred by the inference unit.

Furthermore, a method according to an aspect of the present invention is as follows.

[12] A method for supporting the creation of a game script including natural language data representing explanation text in a game and also including control data for controlling the game, the method being characterized by including:

a step of accepting the input of explanation text in the game; and

a step of inferring, by using a trained model, control explanation text from the explanation text whose input has been accepted, the trained model being generated by causing a pre-trained natural language model to learn processed script text, the pre-trained natural language model having learned in advance grammatical structures and text-to-text relationships concerning natural language text, the processed script text including explanation text included in created game scripts created in advance and control explanation text in the form of natural language data created from control data corresponding to the explanation text.

A program according to an aspect of the present invention is characterized by causing a computer to execute the individual steps of a method according to [9] or [12].

### Advantageous Effects of Invention

The present invention makes it possible to support the creation of a game script in the development of a game having narrativity.

### BRIEF DESCRIPTION OF DRAWINGS

FIG. 1 is a block diagram showing the hardware configuration of a learning support device according to a first embodiment of the present invention.

FIG. 2 is a functional block diagram of the learning support device, according to one embodiment of the present invention.

FIG. 3 is a figure showing an example game script.

FIG. 4 is an illustration showing an example of a game screen 40.

FIG. 5 is a figure showing an example created game script relating to one type of control data.

FIG. 6 is a figure showing an example of processed script text created by a data pre-processing module from the created game script shown in FIG. 5.

FIG. 7 is a figure showing an example conversion table indicating the association between command1 command data and control explanation text.

FIG. 8 is a figure showing example processed script text created by the data pre-processing module from the created game script shown in FIG. 5.

FIG. 9 is a figure showing corresponding relationships between character strings included in image paths and emotions, showing an example conversion table indicating the association between image paths and control explanation text.

FIG. 10 is a flowchart showing a trained-model generation process of the learning support device, according to the one embodiment of the present invention.

FIG. 11 is a block diagram showing the hardware configuration of a generation support device according to a second embodiment of the present invention.

FIG. 12 is a functional block diagram of the generation support device, according to one embodiment of the present invention.

FIG. 13 is a figure showing an example estimation of control explanation text by an inference unit.

FIG. 14 is a flowchart showing a process of automatically creating a game script portion by the generation support device, according to the one embodiment of the present invention.

### DESCRIPTION OF EMBODIMENTS

A device (system) for supporting the creation of a game script, according to an embodiment of the present invention, will be described below with reference to the drawings. The same reference signs signify the same or corresponding parts throughout the drawings unless otherwise specifically mentioned, and there are cases where the vertical to horizontal scale is shown to be different from the real scale for convenience of description. Furthermore, there are cases where descriptions that are more detailed than necessary are omitted for convenience of description. For example, there are cases where detailed descriptions of matters that are already well known and repeated descriptions of substantially the same configurations are omitted.

A learning support device 10 according to a first embodiment of the present invention is a device for generating a trained model in order to support the creation of a game script. A generation support device 50 according to a second embodiment of the present invention is a device for automatically creating at least a portion of game scripts by using a created trained model in order to support the creation of the game script. Although the learning support device 10 is an embodiment of a learning support system constituted of a plurality of devices, etc., the learning support device 10 will be described as a single device in the following embodiment for convenience of description. The same applies to the generation support device 50.

The games in the embodiments of the present invention are games having narrativity, in which a story proceeds while the standing pictures of characters, the words that are uttered by characters, etc. are switched according to what is described in game scripts by a game developer. For example, a game program that is executed on an electronic device such as a smartphone executes processing for a game by loading game scripts.

A game script includes natural language data and control data that are associated in accordance with the content of a game, for example, associated with identifiers corresponding to individual scenes in the game. For example, a game script is created by entering natural language data and control data on the basis of minimum information necessary for the proceeding of the game, such as the words, characters, and the manners of rendering described in scenario text, where the natural language data includes character names and words, and the control data includes character behavior, standing pictures, background images, background music, and sound effects.

The natural language data is data representing natural language text, and includes words of characters and explanation text such as explanations of situations. The control data is data other than the natural language data, and includes command data for controlling the game and data concerning images that are displayed on the screen, such as paths for storing the images. For example, the command data is data for controlling the proceeding of the story, such as character movements and screen transitions, and the command data is described in such a format that control is executed in the game as intended when the command data is loaded according to the game program. The control data can be classified into a plurality of types in accordance with the function and content thereof, such as command data and data concerning images. There are cases where command data, which is a type of control data, can be classified further in accordance with the function and content thereof.

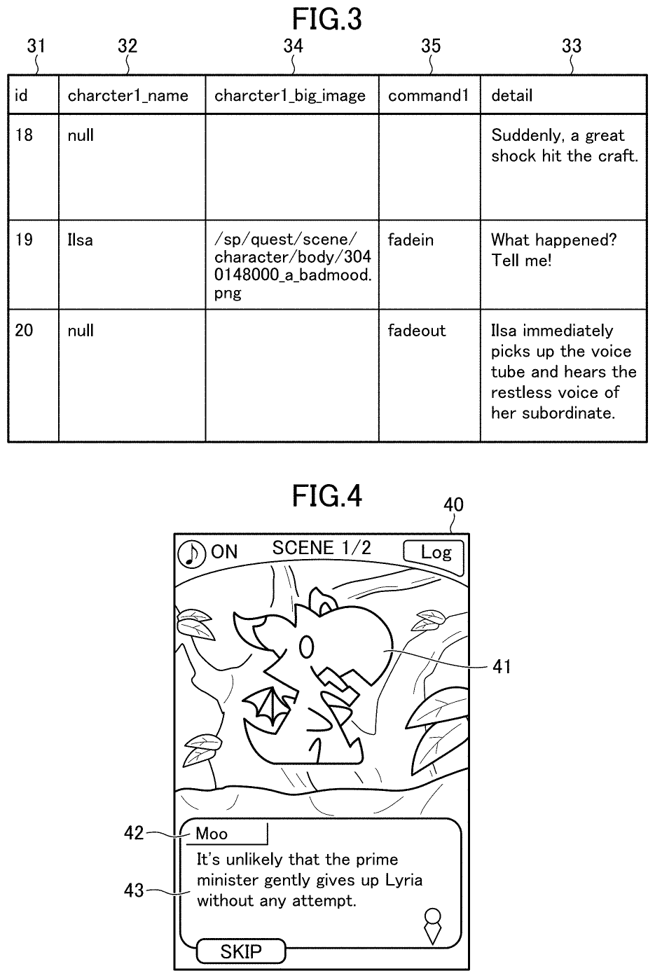

FIG. 3 is a figure showing an example game script. In this embodiment, a game script is data in the form of a matrix. The row elements are identified by IDs 31, and the column elements are data associated with the IDs 31. The column elements associated with the IDs 31 include column elements of character names 32, explanation text 33, image paths 34, and command data 35. Note that the row elements and the column elements may be exchanged.

The individual IDs 31, i.e., the individual rows, correspond to individual scenes in the game, and the individual column elements are associated with the individual scenes in the game by being associated with the IDs 31. Preferably, the IDs 31 include numbers, and the numbers indicate a time-series order. The IDs 31 are an example of identifiers.

The character names 32 are natural language data representing the names of characters that appear. In the game script shown in FIG. 3, only the element on a row character1_name corresponding to one character is specified in the character names 32. In this case, this character corresponds to the speaker character. However, it is possible to increase or decrease the number of elements on the column corresponding to the character names 32 in the game script, so that the game script can include elements on the row of the character names 32 corresponding to one or more characters other than the speaker character. In one preferred example, the character names 32 are character IDs that enable the identification of characters, instead of the names of characters. In this case, the character IDs correspond to character names on a one-to-one basis, where the character names are natural language data, and enable the identification of character names, and thus the character IDs can be considered as natural language data. By loading the game script, it becomes possible for the game program to refer to a table in which the character IDs and the character names are associated.

The explanation text 33 is natural language data representing at least either words that are uttered by characters or explanations of situations.

The image paths 34 indicate paths where character images are stored, and constitute one kind of control data. The game program acquires the character images by accessing the storage locations thereof. For example, in the case where the character name 32 associated with one ID 31 is not specified, such as the case where “null” is described as the character name 32, the explanation text 33 associated with the one ID 31 is natural language data representing an explanation of a situation.

The command data 35 represents a command for controlling the game, corresponding to one scene in the game, and constitutes one kind of control data. For example, the command data 35 is a command specifying the method of displaying a character image acquired via the image path 34 associated with the same ID 31. In the game script shown in FIG. 3, only the element on the row of command1 is described in the command data 35. However, the command data 35 may include the elements of the rows of a plurality of items of command data 35, such as command1 and command2. In this embodiment, command1 is command data concerning control of character and background motion. In this embodiment, the command data 35 of the elements on one column correspond to one type of command data 35. For example, one type of command data 35 is command1, and command1 can include a plurality of kinds of command data, such as “fadein” and “fadeout”. Note, however, that the command data 35 may be configured such that the command data 35 of the elements on a plurality of columns correspond to one type of command data 35. The game script shown in FIG. 3 may include the elements on columns other than the command data 35.

In one example, the command data 35 may include the elements on columns of command data 35 corresponding to the individual characters indicated by the character names 32, and may include the elements on a column of command data 35 not corresponding to any character but corresponding to the entire game. In another example, the elements on one column of the command data 35 are command data concerning control of character and background motion, and the elements on another column of the command data 35 are commands concerning the specification of standing pictures with facial expressions and postures matching the words of characters.

FIG. 4 is an illustration showing an example of a game screen 40. The game screen 40 includes a standing picture 41, a character name 42, and explanation text 43. The standing picture 41 is a picture of a character that appears in the game, and is displayed in accordance with the speaker and changes in the facial expression. The character name 42 is the name of the speaker character. The explanation text 43 is words or an explanation of the situation.

In one example, the game program, upon loading the game script, executes processing for acquiring a character image corresponding to the standing picture 41 via the image path 34 and displaying the acquired character image in the game screen 40. In this case, preferably, the game program executes processing for displaying the character image in accordance with a control method described in the command data 35. In one example, the game program, upon loading the game script, executes processing for acquiring a character name 32 and explanation text 33. In the case where a character name 32 associated with the same ID 31 as the explanation text 33 is specified, the explanation text 33 is words, and the game program executes processing for displaying the character name 42 and the explanation text 43 corresponding to the character name 32 and the explanation text 33 in the game screen 40. In the case where a character name 32 associated with the same ID 31 as the explanation text 33 is not specified, the explanation text 33 is an explanation of the situation, and the game program executes processing for displaying the explanation text 43 corresponding to the explanation text 33 in the game screen 40.

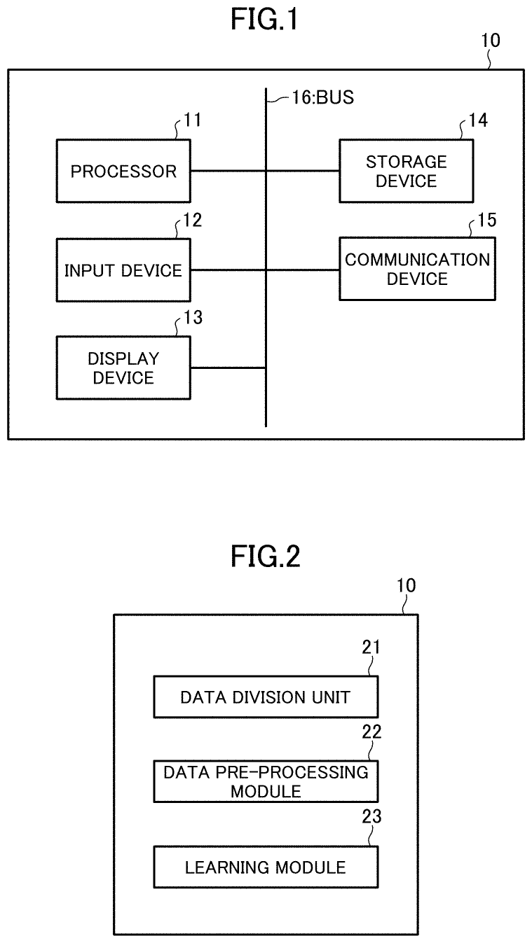

FIG. 1 is a block diagram showing the hardware configuration of a learning support device 10 according to a first embodiment of the present invention. The learning support device 10 includes a processor 11, an input device 12, a display device 13, a storage device 14, and a communication device 15. These constituent devices are connected via a bus 16. Note that interfaces are interposed as needed between the bus 16 and the individual constituent devices. The learning support device 10 has a configuration similar to that of an ordinary server, PC, or the like.

The processor 11 controls the overall operation of the learning support device 10. For example, the processor 11 is a CPU. The processor 11 executes various kinds of processing by loading programs and data stored in the storage device 14 and executing the programs. The processor 11 may be constituted of a plurality of processors.

The input device 12 is a user interface that accepts inputs to the learning support device 10 from a user; for example, the input device 12 is a touchscreen, a touch pad, or buttons. The display device 13 is a display that displays application screens, etc. to the user of the learning support device 10 under the control of the processor 11.

The storage device 14 includes a main storage device and an auxiliary storage device. The main storage device is a semiconductor memory such as a RAM. The RAM is a volatile storage medium that allows high-speed reading and writing of information, and is used as a storage area and a work area when the processor 11 processes information. The main storage device may include a ROM, which is a read-only non-volatile storage medium. The auxiliary storage device stores various programs, as well as data that is used by the processor 11 when executing the programs. The auxiliary storage device may be a non-volatile storage or non-volatile memory of any type that is capable of storing information, which may be of the removable type.

The storage device 14 stores created game scripts, which are game scripts created in advance. The created game scripts are game scripts for training the learning support device 10. The storage device 14 stores character images that are referred to when the created game scripts are loaded.

The communication device 15 is a wireless LAN module that is capable of receiving data from and transmitting data to other computers, such as user terminals and servers, via a network. The communication device 15 may be other types of wireless communication device, such as a Bluetooth (registered trademark) module, or a wired communication device, such as an Ethernet (registered trademark) module or a USB interface.

FIG. 2 is a functional block diagram of the learning support device 10, according to one embodiment of the present invention. The learning support device 10 includes a data division unit 21, a data pre-processing module 22, and a learning module 23. In this embodiment, these functions are realized by the processor 11 executing programs. For example, the programs that are executed are programs stored in the storage device 14 or received via the communication device 15. Since various kinds of functions are realized by loading programs, a portion or the entirety of one part (function) may be provided in another part. Alternatively, these functions may be realized by means of hardware by configuring an electronic circuit or the like for realizing a portion or the entirety of each function.

First, the overall operation of the learning support device 10 will be described. For each type of control data, the learning support device 10 causes the learning module 23 to perform learning by using processed script text created by the data pre-processing module 22, thereby generating a trained model for each type of control data. In the case of learning created game scripts concerning control data of which one type of control data depends on the personalities of characters, the learning support device 10 causes the data division unit 21 to classify the created game scripts on a per-character basis to create created game scripts for each character. In this case, the learning support device 10 causes the learning module 23 to perform learning by using the processed script text created by the data pre-processing module 22 on a per-character basis. In the case of learning created game scripts concerning control data of which one type of control data does not depend on the personalities of characters, the learning support device 10 does not cause the data division unit 21 to classify the created game scripts.

The data division unit 21 classifies the created game scripts on a per-character basis, and stores the per-character created game scripts in the storage device 14. Per-character classification refers to classification on the basis of each character name 32 corresponding to the speaker character. In one preferred example, the data division unit 21 creates created game scripts for each speaker character by identifying the speaker character relating to the data associated with each ID 31 in the created game scripts, i.e., the data on each row, and aggregating the rows of data for each speaker character. The data division unit 21 stores the created game scripts created on a per-character basis in the storage unit 14 on a per-character basis. Note that it is possible to identify the speaker character relating to the data associated with each ID 31, i.e., the data on each row, by referring to the character name. Depending on the type of control data, the data division unit 21 may not perform per-character classification.

The data pre-processing module 22, for each type of control data, creates processed script text by converting the control data included in the created game scripts stored in the storage device 14 into control explanation text, which is natural language data. The processed script text is natural language data including explanation text 33 and control explanation text corresponding to the explanation text 33, and is created on the basis of created game scripts. In the case where the created game scripts are divided by the data division unit 21, the data pre-processing module 22 converts the control data included in the created game scripts stored in the storage device 14 on a per-character basis into control explanation text, thereby creating processed script text on a per-character basis.

In this embodiment, the data pre-processing module 22 includes a plurality of data pre-processing units 122 each having the function of the data pre-processing module 22. Each of the data pre-processing units 122 corresponds to one type among the types of control data included in the created game scripts. Each of the data pre-processing units 122 converts control data corresponding to one type of the control data included in the created game scripts into control explanation text, thereby creating processed script text. The data pre-processing module 22 creates processed script text for each type of control data in this manner. Alternatively, the data pre-processing module 22 may be realized by a single data pre-processing unit or other software modules. For example, in the case where a character that has been caused to perform “fadein” is caused to perform “fadeout”, the data pre-processing unit 122 converts “fadein” and “fadeout” into control explanation text among the command data included in the created game scripts, thereby creating processed script text.

In one example, each of the data pre-processing units 122 converts control data in the created game scripts into control explanation text, and associates or joins the explanation text 33 and control explanation text associated with the same ID 31, thereby creating processed script text. The processed script text is created on the basis of the created game scripts for each row of data associated with an ID 31. Although the processed script text refers to the entire natural language data created from the created game scripts, there are cases where the processed script text refers to natural language data associated with one ID 31 among the data created from the created game scripts.

In one preferred example, for each row of data associated with an ID 31, the data pre-processing unit 122 creates one item of explanation text 33′, such as the one shown in Table 1, by using the natural language data of the character name 32 and the explanation text 33 in the created game scripts. The explanation text 33′ is natural language data that is associated or joined with the control explanation text.

TABLE 1
(Explanation text 33)

(Marker indicating a portion for controlling character
motion), (Front character), (Speaker character)

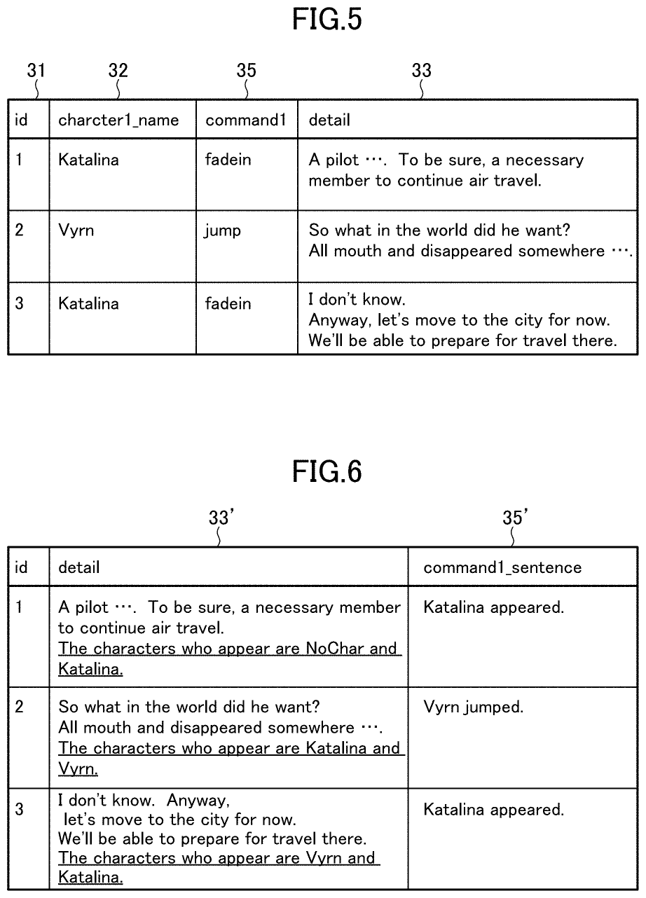

Here, the operation of the data pre-processing module 22 and the learning module 23 in the case where the type of control data to be learned is command1 (command data 35) will be described. FIG. 5 is a figure showing an example of created game scripts relating to one type of control data. FIG. 6 is a figure showing an example of processed script text created by the data pre-processing units 122 from the created game scripts shown in FIG. 5. FIG. 5 shows game scripts relating to command1. Here, command1 is control data concerning the control of character and background motion. In this case, since the control data does not depend on the personalities of characters, the data division unit 21 does not divide the created game scripts on a per-character basis for the one type of control data including command1.

Each of the data pre-processing units 122 processes the natural language data described in the elements on the columns of the character names 32 and the explanation text 33, shown in FIG. 5, into the natural language data described in the elements on the column of the explanation text 33′, shown in FIG. 6. As shown in FIG. 6, each row of the processed script text is constituted of natural language data. Note that although the explanation text 33′ and the control explanation text 35′ are associated with IDs in the processed script text shown in FIG. 6 for the purpose of association with the IDs 31 in the game scripts for convenience of description, it suffices to enable the management of each row of data.

“Marker indicating a portion for controlling character motion”, described in Table 1, corresponds to the natural language text “the characters who appear are” in FIG. 6. The natural language text “NoChar” in FIG. 6 is short for “NoCharacter”, indicating that no character name is specified. In the case where the character name 32 is “null”, the data pre-processing unit 122 creates the natural language data of the explanation text 33′ so that the “character” after the “marker” becomes “NoChar”. Therefore, in the case where neither “Front character” nor “Speaker character” is specified, the description reads “the characters who appear are NoChar and NoChar”.

In FIG. 5, the scene with which the ID 31 is “1” is the first scene, in which “Front character” is absent, and only “Katalina” acting as “Speaker character” is present. In this case, the data pre-processing units 122 created the explanation text 33′ so that the description after the “marker” for the ID 31 read “the characters who appear are NoChar and Katalina”. Furthermore, in FIG. 5, in the scene with which the ID 31 is “2”, “Vyrn” is specified as the character name 32 as “Speaker character”, and “Katalina” as “Speaker character” in the immediately preceding scene is not specified. In this case, the data pre-processing units 122 created the explanation text 33′ so that “Speaker character” was “Vyrn” and “Front character” was “Katalina”.

The storage device 14 stores control-data conversion information indicating the corresponding relationships between control data and control explanation text for each type of control data. For example, in the case where the control data is the command data 35, the control-data conversion information is information associating the individual items of the content of the command data 35 with the individual items of control explanation text, and is stored, for example, in the form of a conversion table. Each of the data pre-processing units 122 converts control data into control explanation text on the basis of the control-data conversion information.

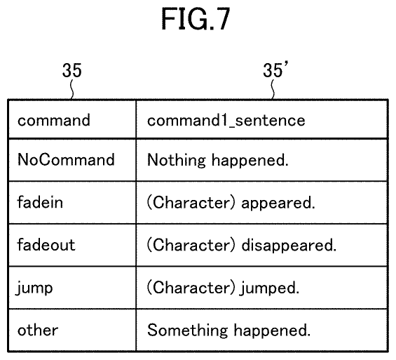

FIG. 7 is a figure showing an example conversion table showing the association between the command data 35 of command1 and the control explanation text 35′. The data pre-processing unit 122 converts the command data 35 shown in FIG. 5 into the control explanation text 35′ shown FIG. 6 by using the conversion table shown in FIG. 7. For example, the data pre-processing unit 122 converts the command data “fadein” into control explanation text “(character) appeared” by using the conversion table shown in FIG. 7.

The learning module 23 generates a trained model for each type of control data by causing a pre-trained natural language model, generated by learning grammatical structures and text-to-text relationships concerning natural language text in advance, to learn processed script text for each type of control data. In the case where processed script text is created for each character by the data pre-processing module 22, the learning module 23 generates a trained model for each character by causing the pre-trained natural language model to learn the processed script text created for each character for each type of control data.

The trained natural language model is a learning model created in advance by learning a huge volume of natural language text through the learning of grammatical structures and the learning of text-to-text relationships. The learning of grammatical structures refers to learning the following three patterns, for example, for the purpose of learning the structure of the sentence “My dog is hairy”: (1) word masking “My dog is [MASK]”; (2) random word substitution “My dog is apple”; and (3) no word operation “My dog is hairy”. The learning of text-to-text relationships refers to, for example, in the case where pairs of two successive sentences to be learned are available, creating original pairs (correct pairs) of two sentences and pairs of randomly selected sentences (incorrect pairs), the former and the latter each constituting one half, and leaning whether or not there is relevance between the sentences as a binary classification problem.

The trained natural language model is stored in another device that is different from the learning support device 10. The learning support device 10 trains the trained natural language model by communicating with the other device via the communication device 15, and acquires the learning model obtained through training from the other device. Alternatively, the learning support device 10 may store the trained natural language model in the storage device 14.

In this embodiment, the learning module 23 includes a plurality of learning units 123 each having the function of the learning module 23. The learning units 123 individually correspond to the plurality of data pre-processing units 122, and each of the learning units 123 individually generates a trained model by causing the pre-trained natural language model to learn the processed script text created by the corresponding data pre-processing unit 122. Alternatively, the learning module 23 may be realized by a single learning unit, other software modules, or the like.

In one preferred example, the pre-trained natural language model is a trained model called BERT, provided by Google LLC. The learning units 123 communicate with the BERT system via the communication device 15, causing BERT to learn the processed script text. In this case, the learning units 123 generate a trained model for each type of control data by fine-tuning the pre-trained natural language model for each type of control data by using the processed script text in the form of natural language data as training data. Fine-tuning refers to re-training the pre-trained natural language model to perform re-weighting of parameters. Therefore, the learning units 123 generate new learning models that are slightly adjusted versions of the pre-trained natural language model by re-training the pre-trained natural language model by using the processed script text.

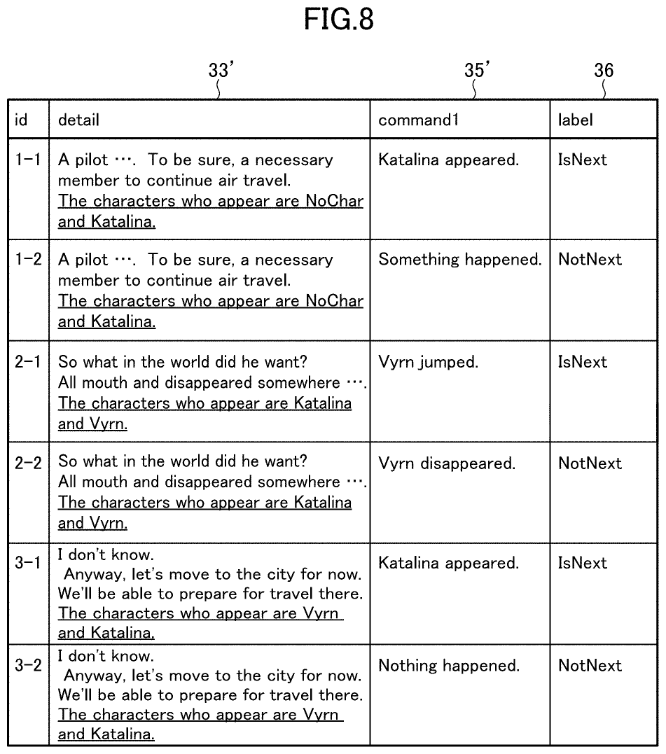

In this embodiment, the learning units 123 cause the pre-trained natural language model to learn text-to-text relationships. The data pre-processing units 122 create processed script text from the created game scripts shown in FIG. 5, which makes it possible for the learning units 123 to learn text-to-text relationships. FIG. 8 is a figure showing an example of processed script text created by the data pre-processing units 122 from the created game scripts shown in FIG. 5. In the processed script text, labels 36 are associated with the explanation text 33′ and the control explanation text 35′. Although the processed script text does not include the labels 36, in FIG. 8, the labels 36 that are assigned by the learning module 23 for the purpose of training the pre-trained natural language model are explicitly shown for convenience of description. Furthermore, although the explanation text 33′ and the control explanation text 35′ are associated with IDs for the purpose of association with the IDs 31 in the game script in the processed script text shown in FIG. 8 for convenience of description, it suffices that it is possible to manage each row of data.

The labels 36 have “IsNext” shown thereon as labels for correctness and “NotNext” shown thereon as labels for incorrectness. As correct pairs, the data pre-processing units 122 create pairs of the explanation text 33′ corresponding to the character name 32 and the explanation text 33 with the ID 31 “1” in the created game scripts shown in FIG. 5 and the control explanation text 35′ corresponding to the command data 35 with the ID 31 “1”. As incorrect pairs, the data pre-processing units 122 create pairs of the explanation text 33′ corresponding to the character name 32 and the explanation text 33 with the ID 31 “1” in the created game scripts shown in FIG. 5 and randomly selected control explanation text 35′. The learning units 123 associate labels 36 indicating “IsNext” with the correct pairs and associate labels 36 indicating “NotNext” with the incorrect pairs.

The learning units 123 cause the pre-trained natural language model to join the explanation text 33′ and the control explanation text 35′ created as correct pairs and to perform learning while considering the results as correct data (assigning labels for correctness), and also to join the explanation text 33′ and the control explanation text 35′ created as incorrect pairs and to perform learning while considering the results as incorrect data (assigning labels for incorrectness). As a modification, in the case where command1 and command2 constitute one type of control data and the control data is one type of control data to be learned, the data pre-processing units 122 are configured to be able to create items of control explanation text 35′ individually corresponding to command1 and command2. In this case, the learning units 123 join the items of control explanation text 35′ individually corresponding to command1 and command2 and handle the result as a single item of control explanation text 35A′, and cause the pre-trained natural language model to learn text-to-text relationships between the explanation text 33′ and the control explanation text 35A′.

Next, the operation of the data pre-processing module 22 and the learning module 23 in the case where the type of control data to be learned is the image paths 34 will be described, mainly regarding differences from the case of the command data 35. The image paths 34 each include a file name constituted of a character string including a character ID and an emotion. For example, in the case where the character ID is “3050”, the file name “3050” indicates an emotion corresponding to “neutral”, the file name “3050_laugh” indicates an emotion corresponding to “laugh”, the file name “3050_angry” indicates an emotion corresponding to “angry”, the file name “3050_concentration” indicates an emotion among “others”, and the file name “3050_a” indicates an emotion among “others”. In this case, the processed script text shown in FIG. 6 includes control explanation text 34′ corresponding to emotions included in the character strings of the image paths 34 instead of control explanation text 35′ corresponding to the command data 35. Furthermore, in this case, since the control data depends on the personalities of characters, the data division unit 21 divides the created game scripts on a per-character basis.

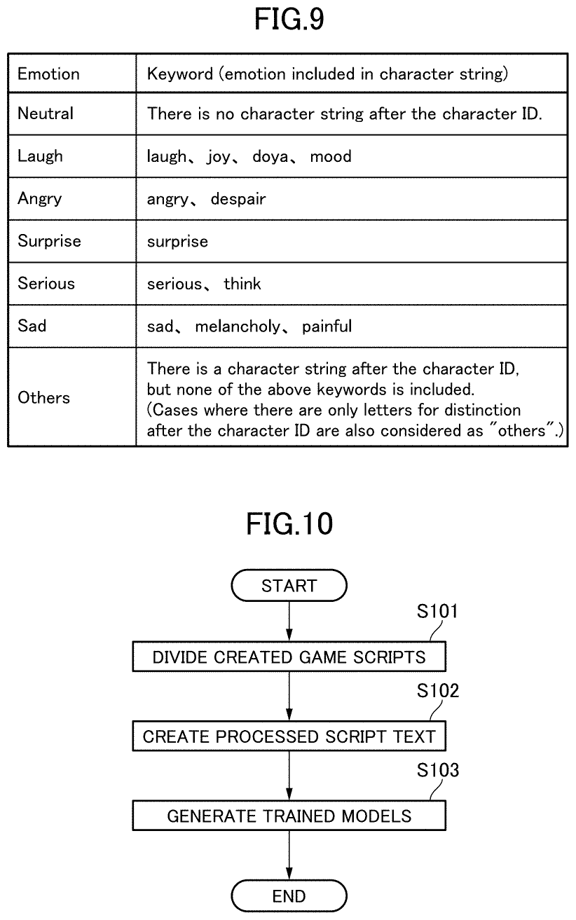

FIG. 9 is a figure showing corresponding relationships between character strings included in the image paths 34 and emotions, showing an example conversion table indicating the association between the image paths 34 and the control explanation text 34′. The data pre-processing units 122 convert the emotions included in the character strings of the image paths 34 into control explanation text 34′ “emotions” by using the conversion table shown in FIG. 9. The data pre-processing units 122 convert the control data included in the created game scripts stored in the storage device 14 on a per-character basis into control explanation text, thereby creating processed script text on a per-character basis. The processed script text in this case includes the “emotions” in the control explanation text 34′ corresponding to the image paths 34 instead of the control explanation text 35′ corresponding to the command data 35 in the processed script text shown in FIG. 6 or FIG. 8. Similarly to the case of control data of command1, as correct pairs, the data pre-processing units 122 create pairs of explanation text 33′ and control explanation text 34′ created on the basis of the created game scripts. Similarly, as incorrect pairs, the data pre-processing units 122 create pairs of explanation text 33 created on the basis of the created game scripts and randomly selected control explanation text 34′.

Next, a process of generating a trained model by the learning support device 10, according to one embodiment of the present invention, will be described with reference to a flowchart shown in FIG. 10. In step 101, the data division unit 21 classifies created game scripts on a per-character basis and stores the per-character created game scripts in the storage device 14.

In step 102, for each type of control data, the data pre-processing module 22 converts the control data included in the created game scripts stored on a per-character basis into control explanation text, thereby creating processed script text on a per-character basis. In step 103, for each type of control data, the learning module 23 generates a trained model for each character by causing the pre-trained natural language model to learn the processed script text created on a per-character basis.

Note, however, that in the case where the data division unit 21 does not divide the created game scripts, the processing in step 101 in this flowchart is not executed. In this case, in step 102, for each type of control data, the data pre-processing module 22 creates processed script text by converting the control data included in the stored created game scripts into control explanation text. In step 103, for each type of control data, the learning module 23 generates a trained model by causing the pre-trained natural language model to learn the created processed script text.

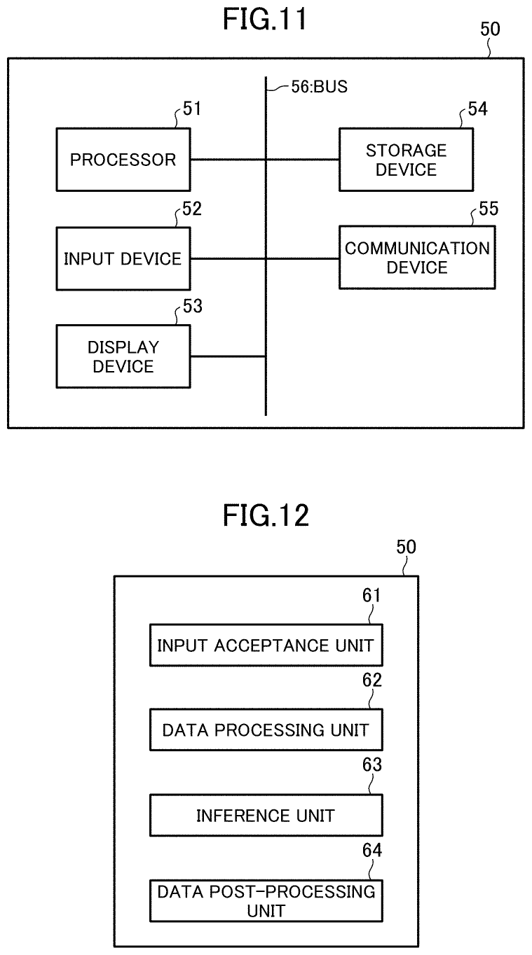

FIG. 11 is a block diagram showing the hardware configuration of a generation support device 50 according to a second embodiment of the present invention. The generation support device 50 includes a processor 51, an input device 52, a display device 53, a storage device 54, and a communication device 55. These constituent devices are connected via a bus 56. Note that interfaces are interposed as needed between the bus 56 and the individual constituent devices. The generation support device 50 has a configuration similar to that of an ordinary server, PC, or the like.

The processor 51 controls the overall operation of the generation support device 50. For example, the processor 51 is a CPU. The processor 51 executes various kinds of processing by loading programs and data stored in the storage device 54 and executing the programs. The processor 51 may be constituted of a plurality of processors.

The input device 52 is a user interface that accepts inputs to the generation support device 50 from a user; for example, the input device 52 is a touchscreen, a touch pad, or buttons. The display device 53 is a display that displays application screens, etc. to the user of the generation support device 50 under the control of the processor 51.

The storage device 54 includes a main storage device and an auxiliary storage device. The main storage device is a semiconductor memory such as a RAM. The RAM is a volatile storage medium that allows high-speed reading and, writing of information, and is used as a storage area and a work area when the processor 51 processes information. The main storage device may include a ROM, which is a read-only non-volatile storage medium. The auxiliary storage device stores various programs, as well as data that is used by the processor 51 when executing the programs. The auxiliary storage device may be a non-volatile storage or non-volatile memory of any type that is capable of storing information, which may be of the removable type.

The storage device 54 stores the trained models for the individual types of control data, generated by the learning module 23 of the learning support device 10. In the case where trained models have been generated on a per-character basis in accordance with the types of control data, the storage device 54 stores the trained models for the individual types of control data and for the individual characters. Furthermore, the storage device 54 stores character images that are referred to when game scripts are loaded. As described earlier, the file name of a character image is constituted of a character string including a character ID and an emotion.

The communication device 55 is a wireless LAN module that is capable of receiving data from and transmitting data to other computers, such as user terminals and servers, via a network. The communication device 55 may be other types of wireless communication device, such as a Bluetooth (registered trademark) module, or a wired communication device, such as an Ethernet (registered trademark) module or a USB interface.

FIG. 12 is a functional block diagram of the generation support device 50, according to one embodiment of the present invention. The generation support device 50 includes an input acceptance unit 61, a data processing unit 62, an inference unit 63, and data post-processing unit 64. In this embodiment, these functions are realized by the processor 51 executing programs. For example, the programs that are executed are programs stored in the storage device 54 or received via the communication device 55. Since various kinds of functions are realized by loading programs, as described above, a portion or the entirety of one part (function) may be provided in another part. Alternatively, these functions may be realized by means of hardware by configuring an electronic circuit or the like for realizing a portion or the entirety of each of the functions.

The input acceptance unit 61 accepts the input of character names 32 and explanation text 33 in a game script. In one example, the input acceptance unit 61 accepts the input of the character names 32 and the explanation text 33 in the game script shown in FIG. 3, and the data whose input has been accepted are associated with the IDs 31. Note, however, that the input acceptance unit 61 may be configured to accept only explanation text 33 in the case where the type of control data that is subject to inference is command1, since the control data does not depend on the personalities of characters.

The data processing unit 62, for each row of data associated with an ID 31, creates natural language data of a single item of explanation text 33′, such as the one given in Table 1, on the basis of the natural language data of the character name 32 and the explanation text 33.

The inference unit 63 infers control explanation text from the explanation text whose input has been accepted by the input acceptance unit 61, by using the trained models for the individual types of control data, or the trained models for the individual types of control data and for individual characters, generated by the learning module 23 of the learning support device 10. The data post-processing unit 64, on the basis of control-data conversion information, creates control data from the control explanation text inferred by the inference unit 63. Specifically, in the case where the type of control data is the command data 35, the data post-processing unit 64 converts the control explanation text into control data on the basis of the control-data conversion information.

In one example, in the case where the type of control data that is subject to inference is command1, the inference unit 63 creates pairs of the explanation text 33′ created by the data processing unit 62 and the control explanation text 35′ corresponding to all the types of command data described in command1. The inference unit 63 inputs the created pairs to the trained model corresponding to command1 and calculates relevance scores. The inference unit 63 selects (outputs) the control explanation text 35′ of the pair having the highest score as the most suitable control explanation text.

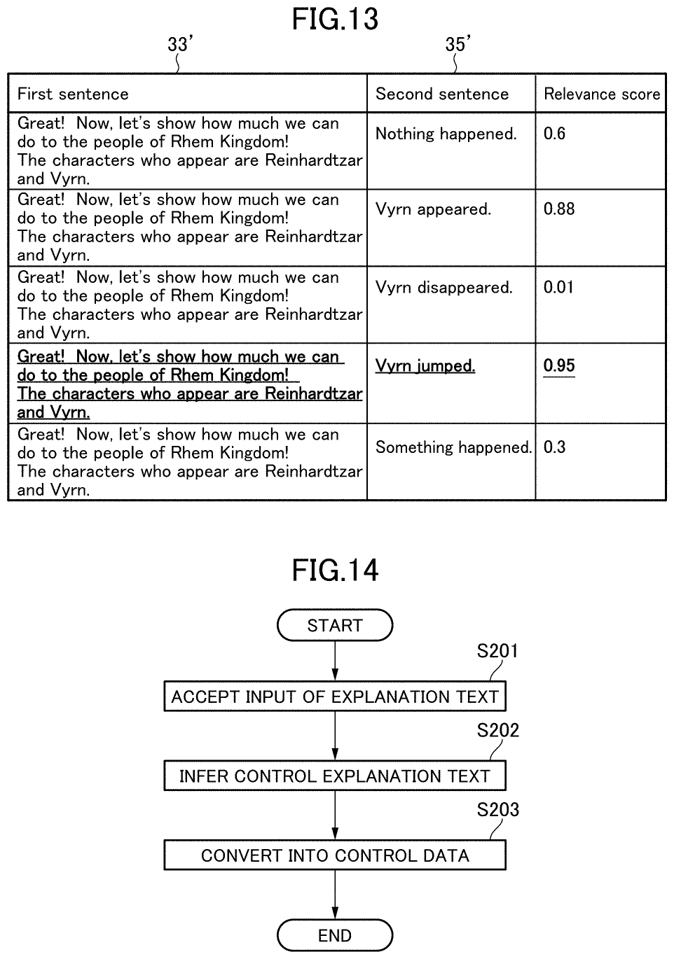

FIG. 13 is a figure showing an example of inference of control explanation text 35′ by the inference unit 63, and Table 2 shows explanation text 33′ created by the data processing unit 62.

TABLE 2
Great! Now, let's show how much we can do to the people of
Rhem Kingdom!
The characters who appear are Reinhardtzar and Vyrn.

Since the current speaker character is “Vyrn” and the immediately previous speaker character is “Reinhardtzar”, the data processing unit 62 created explanation text 33′ by appending “the characters who appear are Reinhardtzar and Vyrn” to the words constituting the explanation text 33. The inference unit 63 creates pairs of the created explanation text 33′ and the respective items of control explanation text corresponding to all the types of command data, specifically, “nothing happened”, “(character) appeared”, “(character) disappeared”, “(character) jumped”, and “something happed”. The items of control explanation text for all the types, mentioned above, correspond to all the types of command data, i.e., “NoCommand”, “fadein”, “fadeout”, “jump”, and “other”. The inference unit 63 inputs the created pairs to the trained model corresponding to command1, calculates relevance scores, and selects “(character) jumped”, which has the highest score, as the control explanation text that is most suitable for the explanation text 33.

The data post-processing unit 64 converts the control explanation text inferred by the inference unit 63 into control data, and outputs the explanation text 33 whose input has been accepted by the input acceptance unit 61, as well as the control explanation text 35′ corresponding to the explanation text 33. In one preferred example, the storage device 54 stores control-data conversion information for each type of control data, stored in the storage device 14 of the learning support device 10. The data post-processing unit 64 converts control explanation text into control data (creates control data) on the basis of the control-data conversion information. The data post-processing unit 64 is configured to be able to output the converted control data to the corresponding point in the game script.

In one example, in the case where the type of control data that is subject to inference is the image paths 34, the inference unit 63 creates pairs of the explanation text 33′ created by the data processing unit 62 and the respective items of control explanation text 34′ corresponding to all the kinds of emotions included in the image paths 34. The inference unit 63 inputs the created pairs to the trained model corresponding to the character corresponding to the character name 32 accepted by the input acceptance unit 61 and also corresponding to the image paths 34, and calculates relevance scores. The inference unit 63 inputs the created pairs to the trained model corresponding to the image paths 34, calculates relevance scores, and selects the control explanation text 34′ having the highest score as the control explanation text that is most suitable for the explanation text 33. For example, the data post-processing unit 64 converts the control explanation text into a character string including an emotion, such as “laugh” or “angry”, on the basis of the control-data conversion information. The data post-processing unit 64 creates an image path (control data) at which the file name including the character ID identified from the explanation text 33′ and including the converted character string is stored. The data post-processing unit 64 is configured to be able to output the created image path to the corresponding point in the game script. In another example, since the control explanation text 34′ is natural language data corresponding to emotions, the generation support device 50 is configured to be able to directly output the control explanation text 34′ having the highest score to the corresponding point in the game script in the form like a comment, without having to execute processing by the data post-processing unit 64.

Next, a process of automatically creating a game script portion by the generation support device 50, according to one embodiment of the present invention, will be described with reference to a flowchart shown in FIG. 14. In step 201, the input acceptance unit 61 accepts the input of a character name 32 and explanation text 33. In step 201, the data processing unit 62 creates explanation text 33′, such as that given in Table 1, on the basis of the natural language data of the character name 32 and the explanation text 33.

In step 202, by using the trained model for each type of control data, generated by the learning module 23 of the learning support device 10, the inference unit 63 infers control explanation text from the explanation text whose input has been accepted by the input acceptance unit 61. Specifically, the inference unit 63 outputs one item of control explanation text. In step 203, the data post-processing unit 64 converts the control explanation text inferred (output) by the inference unit 63 into control data, and outputs the explanation text 33 whose input has been accepted by the input acceptance unit 61, as well as the control explanation text corresponding to the explanation text 33.

Next, the main operations and advantages of the learning support device 10 and the generation support device 50 according to the embodiments of the present invention will be described. In the embodiment of the present invention, the learning support device 10 includes the data pre-processing module 22 and the learning module 23. In order to use created game scripts as training data, the data pre-processing module 22 converts control data for training into control explanation text in the form of natural language text, thereby creating processed script text. The data pre-processing module 22 is configured to be able to create processed script text for each type of control data and for each character. The learning module 23 causes the pre-trained natural language model to learn the processed script text, thereby generating trained models. The learning module 23 is configured to be able to generate a trained model for each type of control data and for each character by using processed script text created for each type of control data and for each character.

As described above, in this embodiment, the learning support device 10 converts control data into natural language text, thereby converting all the data for training into natural language text, and generates trained models by re-training a pre-trained natural language model, such as BERT, by using the training data converted into natural language text.

With this configuration, this embodiment makes it possible to generate trained models for realizing the automatic creation of at least a game script portion by using created game scripts.

It is possible to generate a trained model for each type of control data, and further for each character. This makes it possible to generate independent trained models corresponding to the types of control data to be automatically created, as well as the types of characters. That is, it becomes possible to generate different trained models corresponding to a plurality of characters or subjects of estimation (types of control data). This makes it possible to generate trained models that can be applied to a game having a plurality of kinds of narrativity with different characters or control data.

The generation support device 50 includes the inference unit 63 and the data post-processing unit 64. The inference unit 63 is configured to be able to infer and output control explanation text for each type of control data, for example, upon accepting the input of words, by using a trained model generated by the learning support device 10. The inference unit 63 is configured to be able to infer and output control explanation text in accordance with the type of control data, and further on a per-character basis. The data post-processing unit 64 is configured to be able to convert control explanation text, which is natural language data output by the inference unit 63, into control data by using control-data conversion information. The data post-processing unit 64 is configured to be able to output the converted control data to the corresponding point in the game script.

With this configuration, this embodiment makes it possible to automatically output control data when a character name and words are input to a game script. With this semi-automation of the work of creating game scripts, which has hitherto been conducted through manual inputs, it becomes possible to reduce the labor of game developers necessary for creating game scripts. As described above, it becomes possible to support the creation of at least a game script portion.

Furthermore, in this embodiment, the learning support device 10 generates training data by combining natural language data, without having to use tags such as XML tags. With this configuration, there is no need for tag specifications or annotations. This makes it possible to improve the efficiency of the process of creating game scripts, which makes it possible to reduce the labor of game developers necessary for creating game scripts.

Note that, in order to learn natural language text, it has hitherto been necessary to perform the work of annotation for adding attribute information to the natural language text to be learned, and it has been necessary to manually read all the training data and to add tags in order to prepare training data. The learning support device 10 according to this embodiment utilizes, for example, BERT (“Devlin, Jacob and Chang, Ming-Wei and Lee, Kenton and Toutanova, Kristina, BERT: Pre-training of Deep Bidirectional Transformers for Language Understanding, 2018, arXiv preprint arXiv:1810.04805.”). This enables learning just by automatically adding natural language text including attribute information necessary for estimation to words, without having to add tags.

The operations and advantages described above also apply similarly to other embodiments and other examples unless otherwise specifically mentioned.

Another embodiment of the present invention may be an automatic-creation support device including the configurations of the learning support device 10 and the generation support device 50 described above. The automatic-creation support device may be realized as an automatic-creation support system constituted of a plurality of devices or the like or as a system including the learning support device 10 and the generation support device 50.

In another embodiment of the present invention, the learning support device 10 does not include the data division unit 21 in the case where there is no control data that depend on characters or in the case where there is no need to perform learning on a per-character basis.

In another embodiment of the present invention, in the case where it is not possible to classify control data into a plurality of types on the basis of functions, or in the case where there is no need for classification, the learning support device 10 and the generation support device 50 do not execute each processing step for each type of control data. For example, the data pre-processing module 22, while not performing classification per control-data type, creates processed script text by converting the control data included in the created game scripts stored in the storage device 14 into control explanation text in the form of natural language data, and the learning module 23, while not performing classification per control-data type, generates trained models by causing the pre-trained natural language model to learn processed script text. Also in this embodiment, the data division unit 21 can classify created game scripts on a per-character basis, and can store the per-character created game scripts in the storage device 14. In this case, the data pre-processing module 22 creates processed script text on a per-character basis, and the learning module 23 generates per-character trained models for each type of control data.

In another embodiment of the present invention, a game script is structured data in a tree structure instead of data in the form of a matrix. In this case, the identifiers of row elements in the case of the matrix-form data are associated with the identifiers or paths of the tree nodes, and the individual column elements are associated with the individual nodes.

Another embodiment of the present invention may be a program for realizing the functions or the information processing shown in the flowcharts in the above-described embodiment of the present invention, or a computer-readable storage medium storing the program. Furthermore, another embodiment of the present invention may be an electronic device for realizing by itself the functions or the information processing shown in the flowcharts in the above-described embodiment of the present invention. Furthermore, another embodiment of the present invention may be a method for realizing the functions or the information processing shown in the flowcharts in the above-described embodiment of the present invention. Furthermore, another embodiment of the present invention may be a server that is capable of providing a computer with a program for realizing the functions or the information processing shown in the flowcharts in the above-described embodiment of the present invention. Furthermore, another embodiment of the present invention may be a virtual machine for realizing the functions or the information processing shown in the flowcharts in the above-described embodiment of the present invention.

The processing or operation described above may be modified freely as long as no inconsistency arises in the processing or operation, such as an inconsistency that a certain step utilizes data that may not yet be available in that step. Furthermore, the examples described above are examples for explaining the present invention, and the present invention is not limited to those examples. The present invention can be embodied in various forms as long as there is no departure from the gist thereof.

### REFERENCE SIGNS LIST

10 Learning support device
11 Processor
12 Input device
13 Display device
14 Storage device
15 Communication device
16 Bus
21 Data division unit
22 Data pre-processing module
23 Learning module
31 ID
32 Character name
33, 33′ Explanation text
34 Image path
34′ Control explanation text
35 Command data
35′ Control explanation text
36 Label
40 Game screen
41 Standing picture
42 Character name
43 Explanation text
50 Generation support device
51 Processor
52 Input device
53 Display device
54 Storage device
55 Communication device
56 Bus
61 Input acceptance unit
62 Data processing unit
63 Inference unit
64 Data post-processing unit
122 Data pre-processing unit
123 Learning unit

1. A system for supporting the creation of a game script including natural language data representing explanation text in a game and also including control data for controlling the game, the natural language data and the control data being associated in accordance with the content of the game, the system comprising:
a data pre-processing module that converts control data included in created game scripts created in advance into control explanation text in the form of natural language data and that creates processed script text including the explanation text and control explanation text corresponding to the explanation text; and
a learning module that generates a trained model by causing a pre-trained natural language model to learn the processed script text, the pre-trained natural language model having learned in advance grammatical structures and text-to text relationships concerning natural language text.

2. The system according to claim 1, wherein:
the control data can be classified into a plurality of types on the basis of functions,
the data pre-processing module, for each type of control data, converts control data included in created game scripts created in advance into control explanation text in the form of natural language data and creates processed script text including the explanation text and control explanation text corresponding to the explanation text, and
the learning module generates a trained model for each type of control data by causing the pre-trained natural language model to learn the processed script text for each type of control data, the pre-trained natural language model having learned in advance grammatical structures and text-to-text relationships concerning natural language text.

3. The system according to claim 2, wherein:
the data pre-processing module includes a plurality of data pre-processing units, and one of the data pre-processing units creates processed script text by converting control data corresponding to one type of control data included in created game scripts into control explanation text, whereby the data pre-processing module creates processed script text for each type of control data, and
the learning module includes a plurality of learning units individually corresponding to the plurality of data pre-processing units.

4. The system according to claim 1, wherein the learning module generates a trained model by fine-tuning the pre-trained natural language model while using the processed script text as training data.

5. The system according to claim 1, wherein:
the processed script text further includes explanation text and randomly selected control explanation text, and
the learning module generates a trained model by causing the pre-trained natural language model to learn, as correct data, explanation text included in the processed script text and control explanation text corresponding to the explanation text, and to learn, as incorrect data, the explanation text and the randomly selected control explanation text.

6. The system according to claim 1, wherein the game script is matrix-form data or structured data, and includes a plurality of identifiers individually corresponding to individual scenes in the game, as well as natural language data and control data associated with the identifiers.

7. The system according to claim 6, wherein:
the game script further includes natural language data representing character names associated with identifiers,
the system further includes a data division unit that classifies the created game scripts on a per-character basis and that stores the per-character created game scripts,
the data pre-processing module, on a per-character basis, converts control data included in created game scripts into control explanation text and creates processed script text including the explanation text and control explanation text corresponding to the explanation text, and
the learning module generates a trained model for each character by causing the pre-trained natural language model to learn the processed script text on a per-character basis.

8. The system according to claim 1, wherein:
the data pre-processing module converts control data into control explanation text on the basis of conversion information indicating corresponding relationships between control data and control explanation text, and
the system includes:
an input acceptance unit that accepts the input of explanation text in the game;
an inference unit that infers, by using a trained model, control explanation text from explanation text whose input has been accepted by the input acceptance unit, the trained model being generated by causing a pre-trained natural language model to learn processed script text, the pre-trained natural language model having learned in advance grammatical structures and text-to-text relationships concerning natural language text, the processed script text including explanation text included in created game scripts created in advance and control explanation text in the form of natural language data created from control data corresponding to the explanation text; and
a data post-processing unit that creates, on the basis of the conversion information, control data from the control explanation text inferred by the inference unit.

9. A method of generating a trained model for supporting the creation of a game script including natural language data representing explanation text in a game and also including control data for controlling the game, the natural language data and the control data being associated in accordance with the content of the game, the method comprising:
a step of converting control data included in created game scripts created in advance into control explanation text in the form of natural language data and creating processed script text including the explanation text and control explanation text corresponding to the explanation text; and
a step of generating a trained model by causing a pre-trained natural language model to learn the processed script text, the pre-trained natural language model having learned in advance grammatical structures and text-to-text relationships concerning natural language text.

10. A system for supporting the creation of a game script including natural language data representing explanation text in a game and also including control data for controlling the game, the natural language data and the control data being associated in accordance with the content of the game, the system comprising:
an input acceptance unit that accepts the input of explanation text in the game; and
an inference unit that infers, by using a trained model, control explanation text from explanation text whose input has been accepted by the input acceptance unit, the trained model being generated by causing a pre-trained natural language model to learn processed script text, the pre-trained natural language model having learned in advance grammatical structures and text-to-text relationships concerning natural language text, the processed script text including explanation text included in created game scripts created in advance and control explanation text in the form of natural language data created from control data corresponding to the explanation text.

11. The system according to claim 10, further comprising a data post-processing unit that creates, on the basis of conversion information indicating corresponding relationships between control data and control explanation text, control data from the control explanation text inferred by the inference unit.

12. A method for supporting the creation of a game script including natural language data representing explanation text in a game and also including control data for controlling the game, the method comprising:
a step of accepting the input of explanation text in the game; and
a step of inferring, by using a trained model, control explanation text from the explanation text whose input has been accepted, the trained model being generated by causing a pre-trained natural language model to learn processed script text, the pre-trained natural language model having learned in advance grammatical structures and text-to-text relationships concerning natural language text, the processed script text including explanation text included in created game scripts created in advance and control explanation text in the form of natural language data created from control data corresponding to the explanation text.

13. A non-transitory computer readable medium storing a program for causing a computer to execute the individual steps of the method according to claim 9.
